(19) United States
(12) Patent Application Publication
(10) Pub. No.: US 2020/0384478 A1
(43) Pub. Date: Dec. 10, 2020

(54) PAPER SHREDDING DEVICE WITH PAPER MANAGEMENT DEVICE

(71) Applicant: WOWSOFT CO., LTD., Seoul (KR)

(72) Inventors: Jong Sang BAE, Seoul (KR); Tae Kyou YOUN, Anyang-si, Gyeonggi-do (KR); Seung Chan BAEK, Goyang-si, Gyeonggi-do (KR)

(73) Assignee: WOWSOFT CO., LTD., Seoul (KR)

(21) Appl. No.: 16/605,742

(22) PCT Filed: Apr. 16, 2018
(86) PCT No.: PCT/KR2018/004388

§ 371 Date: Oct. 16, 2019

(30) Foreign Application Priority Data
Apr. 19, 2017 (KR) 10-2017-0050689

(51) Int. Cl. B02C 25/00; B02C 18/00; B02C 18/22; G06F 3/041; G06F 3/14; G06K 19/06; G06K 7/10; G06K 7/08

(52) U.S. Cl. CPC B02C 25/00; B02C 18/0007; B02C 18/2283; B02C 18/2291; G06K 7/087; G06F 3/14; G06K 19/06037; G06K 7/10366; G06F 3/041

(57) ABSTRACT

The present invention relates to a document shredding apparatus having a document management apparatus. The present invention relates to a document shredder (10) comprising: a document feeder (121) formed on an upper portion of a case (120); a shredding portion (12) positioned below the document feeder (121) in the case (120) for shredding documents fed from the document feeder (121); and a collection box (125) for receiving waste paper shreds shredded by the shredding portion (12), wherein at least one document shredder (10) includes a server (20) which is located in a terminal for managing documents and networked to the document shredder (10) to manage the documents, wherein the server (20) is configured to store information and images of documents requested to be shredded from the document shredder (10), thereby safely managing discarded documents.

### TECHNICAL FIELD

The present invention relates to a document shredding apparatus having a document management apparatus.

More particularly, the present invention relates to a document shredding apparatus having a document management apparatus, wherein the document shredding apparatus includes a means configured to authenticate a person who requests that documents be shred and a means configured to acquire information about documents that are shred, wherein document information is stored in the document management apparatus, which is connected to the document shredding apparatus over a network, and wherein the document shredding apparatus compares the document information acquired from the means configured to acquire the document information with the document information stored in the document management apparatus in order to determine whether to shred documents requested to be shred, whereby it is possible to improve security of documents that are discarded and in addition to manage whether documents to be shred have been normally discarded.

### BACKGROUND ART

Documents requiring security are discharged outside without official approval or procedure, whereby various security incidents occur. In particular, since documents requiring security include important information of companies or public institutions, business losses, such as property damage or strategy exposure, occur.

Consequently, companies or public institutions have strengthened security of documents that are shred outside and have given employees improved security education. However, there is a limit in preventing documents from being abnormally shred merely through the security education of employees.

A general method of shredding documents is shredding the documents using a document shredding apparatus. Consequently, various kinds of document shredding apparatuses have been popularized.

A general document shredding apparatus is configured to shred documents immediately when the documents are introduced thereinto. Such a document shredder does not include a means configured to recognize and sort documents. Once documents are introduced, therefore, the documents are immediately shred.

The document shredding apparatus is not capable of acquiring data of documents that are discarded or relevant information, for example, information about a person who shreds the documents. As a result, it is not possible to manage whether documents to be shred have been normally discarded.

Meanwhile, a large number of documents stored for a predetermined period of time must be designated as documents to be discarded and must be discarded according to business regulations. However, it is necessary to check the stored documents one by one in order to confirm whether the documents to be discarded are stored without being discarded, which is difficult in terms of management.

In addition, documents to be discarded are provided to an outside partner that discards documents. The outside partner records documents to be discarded and then discards the documents. During this procedure, the documents may be discharged outside, and it is not possible for a client to confirm whether the documents have been normally discarded.

Accordingly, various kinds of document shredders have been popularized in order to prevent documents from being shred without normal approval and in addition to prevent documents from being discharged outside due to carelessness.

As an example, Korean Patent No. 10-1656073 entitled SECURITY ENHANCEMENT DEVICE OF DOCUMENT SHREDDER discloses a document shredder including an authentication means installed to generate a signal for authentication using an ambient light sensor, a shredding device installed such that an object bypasses a cutter in a predetermined condition, and a controller configured to control output to the shredding device in response to input of the authentication means.

The authentication means further includes a camera for acquiring a user image and a card reader for reading out an identification card in order to process authentication using a plurality of inputs, the shred device includes a scanner for converting the contents of the object into digital data, a shredding stand installed to change the transfer path of the object, a chute installed adjacent to the shredding stand in order to form a bypass path, and a storage box installed at the lower end of the chute for storing the object that is bypassed, and the controller includes a shredding stand for guiding the bypass of the object in the case in which a keyword input through a touchscreen is identical to the data of the scanner as the result of comparison therebetween.

The security enhancement device of the document shredder performs facial recognition or recognizes RFID information of an employee card such that documents can be discarded in a bundle only after authentication of the employee, whereby it is possible to provide a document shredder configured such that only security is enhanced.

This document shredder is not capable of storing images of the discarded documents. As a result, it is not possible to restore documents that have been shred when it is necessary to confirm the contents of the documents after being shred or to restore documents that have been shred on purpose or due to carelessness.

In addition, documents that are shred cannot be systematically managed in a database. As a result, it is not possible to confirm whether documents to be discarded are stored without being discarded and to confirm whether the documents to be discarded have been normally discarded, whereby there is a problem in managing security documents.

### DISCLOSURE

### Technical Problem

It is an object of the present invention to provide a document shredding apparatus including an authentication means capable of authenticating the identity of a person who requests that documents be shred and a means capable of storing information about documents that are shred, wherein the document shredding apparatus is capable of confirming whether documents to be discarded are stored without being discarded and whether documents to be discarded have been normally discarded, thereby enhancing management and security of documents.

It is another object of the present invention to provide a document shredding apparatus including an authentication means capable of authenticating the identity of a person who requests that documents be shred and a means capable of storing information about documents that are shred, wherein the document shredding apparatus further includes a server connected to the document shredding apparatus over a network in order to manage documents to be discarded and to perform user authentication, thereby enhancing management and security of documents.

It is a further object of the present invention to provide a document shredding apparatus configured such that image information of documents including information about documents requested to be shred is stored in a server, whereby it is possible to reconfirm the contents of documents that have been discarded due to the lapse of document retention duration and in addition to restore documents that have been discarded due to carelessness, and therefore it is possible to enhance management and security of documents while providing convenience in managing documents.

The objects of the present invention are not limited to the above-mentioned object, and other objects that have not been mentioned above will become evident to those skilled in the art from the following description.

### Technical Solution

In accordance with the present invention, the above objects can be accomplished by the provision of a document shredding apparatus including a document feeder formed at the upper part of a case, a shredding unit disposed in the case so as to be located under the document feeder, the shredding unit being configured to shred documents introduced thereinto, and a collection box configured to collect scraps of the documents shred by the shredding unit, wherein at least one document shredding apparatus is located at a terminal configured to manage documents, and the document shredding apparatus includes a server connected to the document shredding apparatus over a network, the server being configured to manage documents.

The document shredding apparatus may include an authentication means configured to authenticate a person who requests that documents be shred, a display unit configured to display a shredding process of documents shred while passing through the shredding unit, an image generation means configured to generate images of the documents requested to be shred, which have been supplied from the document feeder after authentication has been completed by the authentication means, a communication means configured to transmit authentication information of the person who requests that documents be shred, acquired from the authentication means, and the images of the documents requested to be shred, acquired from the image generation means, to the server, and a guide means configured to transfer documents from the image generation means to the shredding unit.

The server may include a separate printing system, a communication means connected to the document shredding apparatus over a network, and a document shredding management unit configured to store information about a document identification means of security documents generated as the result of being printed by the printing system, employee information of the person who requests that documents be shred, input through the authentication means of the document shredding apparatus, image and document information of the documents requested to be shred, generated by and received from the image generation means, document information of non-security documents input through the display unit, and the result of shredding of the documents requested to be shred.

Both documents having a document identification means and documents having no document identification means may be used as documents that are placed on the document feeder and shred.

The document identification means, which is provided to distinguish between general documents and security documents, may be constituted by a quick response (QR) code or a barcode. The document identification means may be recognized by a document management apparatus according to an embodiment of the present invention, a description of which will follow, and the document management apparatus may read out various kinds of information from the document identification means.

The information read out from the document identification means may include information about a document identifier. In addition, the information may further include information about a document writer, version information of documents, a document generation date, and a document discard date. However, the present invention is not limited thereto.

The authentication means may allow authentication information of the person who requests that documents be shred to be input therethrough, and one of a fingerprint recognizer, an iris recognizer, an IC card reader, a magnetic card reader, and an RFID reader is adopted as the authentication means. In the case in which a single authentication means, including a touchpad that is capable of digitizing the signature of a user or a keypad that allows user information, such as employee number, to be input therethrough, or a plurality of authentication means is further included, it is possible to drive the apparatus only in the state in which the identity of the person who requests that documents be shred is confirmed and authenticated.

Consequently, document shredding work may be performed by a limited number of users, whereby it is possible to provide an improved security function.

The image generation means may include a scanner or a digital camera. The image generation means may read out the document identification means of the documents requested to be shred, may generate images of the documents, may transmit the read-out document identification means and the generated document images to the server via the communication means, and may output a signal for displaying non-security documents having no document identification means on the display unit.

The display unit may display a process of guiding the input of document information about non-security documents generated by the image generation means or documents having no document identification means, and may include a touchscreen that allows the document information and a control command to be performed by the controller to be input therethrough.

The guide means may include a pair of guide chutes installed so as to be spaced apart from each other by an appropriate distance in order to guide the documents requested to be shred, discharged from the image generation means (112), a pair of feeding rollers installed so as to be spaced apart from the guide chutes by an appropriate distance, and a driving device configured to drive the pair of feeding rollers, whereby the guide means may guide the documents discharged from the image generation means to the shredding unit.

The guide chutes may include a first inclined feeding unit having an inlet side located at a discharge port of the image generation means, the inlet side being formed so as to be inclined in order to smoothly receive the documents discharged from the image generation means, a curved portion extending from the first inclined feeding unit, and a second inclined feeding unit extending from the curved portion so as to reach an inlet side of the shredding unit, whereby the guide chutes may supply the documents requested to be shred, discharged from the image generation means, to the shredding unit.

The communication means included in each of the document shredding apparatus and the server may be a communication module for accessing a networking system, such as the Internet or an intranet, and may perform communication between the document shredding apparatus and the server according to a predetermined protocol. Preferably, the communication means is based on Ethernet constituting a short-range communication network.

The document shredding management unit included in the server may further include a construction capable of storing a document identification means of security documents in a storage means immediately when the security documents are printed by a printer in order to manage the security documents.

In the present invention, as described above, the document shredding apparatus may include the authentication means configured to confirm the identity of the person who requests that documents be shred, whereby it is possible to shred only documents to be shred, introduced into the document feeder by the person who requests that documents be shred, the identity of whom has been authenticated.

Consequently, document shredding may be performed by a limited number of users, and data about the person who requests that documents be shred are stored in the server in real time, whereby it is possible to provide an improved security function.

As the person who requests that documents be shred is authenticated, the documents to be shred may be supplied from the document feeder to the shredding unit via the image generation means such that the documents are shred by the shredding unit.

The document images generated by the image generation means or the security document data read-out from the document recognition means may be stored in the storage means of the document shredding management unit included in the server, which is installed at a remote place, and at the same time may be compared with security document information stored in the storage means in advance.

For general documents having no document identification means, brief information about documents to be shred may be stored in the server using the input means including the touchpad included in the document shredding apparatus.

Guidance to a process of inputting the brief information about the documents to be shred may be displayed on the display unit including the touchpad.

The brief information may be information, such as document number, document generation date, relevant department, and the person in charge, and document images of the documents requested to be shred, and this information may include document images generated by the image generation means.

When the input of the person who requests that documents be shred through the input means is completed and stored in the server, shredding work of the documents requested to be shred may be commenced, and the result of shredding may be stored in the server.

The shredding work of the documents requested to be shred may be performed by the rollers of the guide means being driven to supply the documents requested to be shred to the shredding unit and the shredding unit shredding the supplied documents requested to be shred.

According to the present invention, as described above, information about documents requested to be shred generated by the image generation means may be stored in the server, whereby it is possible to manage whether documents having expired document retention duration have been discarded.

As a result, in the case in which documents not to be shred, i.e. documents having unexpired document retention duration, or documents that have been shred and discarded by mistake are needed again, it is possible to reprint the documents using document images stored at the time of shredding after confirmation through the server.

### Advantageous Effects

A document shredding apparatus according to the present invention includes an authentication means configured to authenticate a person who requests that documents be shred and a means configured to confirm documents that are shred, and a server is connected to the document shredding apparatus over a network in order to manage documents to be shred and to perform user authentication, whereby it is possible to enhance security of documents.

In addition, information of documents printed by a printing system and whether documents requested to be discarded have been shred are stored, whereby it is possible to confirm whether documents to be discarded are stored without being discarded and to confirm whether documents to be discarded have been normally discarded, and therefore it is possible to enhance management of documents.

Furthermore, document image information including information about documents requested to be discarded is stored in the server, whereby it is possible to reconfirm the contents of documents that have been discarded due to the lapse of document retention duration and in addition to restore documents that have been discarded due to carelessness, and therefore it is possible to provide convenience in managing documents.

It should be noted that effects of the present invention are not limited to the effects of the present invention as mentioned above, and other unmentioned effects of the present invention will be clearly understood by those skilled in the art from an embodiment described below.

### DESCRIPTION OF DRAWINGS

FIG. 1 is a system configuration view of a document shredding apparatus according to an embodiment of the present invention.

FIG. 2 is a system block diagram of the document shredding apparatus according to the embodiment of the present invention.

FIG. 3 is a perspective view showing the external appearance of the document shredding apparatus according to the embodiment of the present invention.

FIG. 4 is a vertical sectional view showing the internal structure of the document shredding apparatus according to the embodiment of the present invention.

FIG. 5 is an enlarged view of a guide means of the present invention.

### BEST MODE

Features and advantages of the present invention will be more clearly understood from the following detailed description of an embodiment taken in conjunction with the accompanying drawings.

Before describing the embodiment of the present invention, it should be noted that applications of the present invention are not limited by the details of the construction and arrangement of components described in the following embodiment and shown in the drawings. The present invention may be realized and embodied through other embodiments, and may be performed using various methods. In addition, the expressions and technical terms used in the embodiment regarding the terms, such as the direction of a device or an element, are used merely to simplify the description of the present invention, and do not indicate or mean that the relevant device or element should have a specific direction.

Also, it should be noted that terms or words used in this specification and the claims are not to be interpreted as having ordinary and dictionary-based meanings but as having meanings and concepts coinciding with the technical idea of the present invention based on the principle that the inventors may properly define the concepts of the terms in order to explain the invention in the best method.

The description given in this specification and the construction shown in the accompanying drawings are related to the most preferred embodiment, and does not cover all technical ideas of the present invention, and therefore it should be understood that there may be various equivalents and modifications capable of substituting for the same at the time of filing of the present application.

Consequently, the present invention is not limited to the suggested embodiment, and it is obvious that various modifications and alternations are possible by a person having an ordinary skill in the art to which the present invention pertains within the technical idea of the present invention and an equivalent range of the technical idea described in the appended claims.

Hereinafter, an embodiment of the present invention will be described.

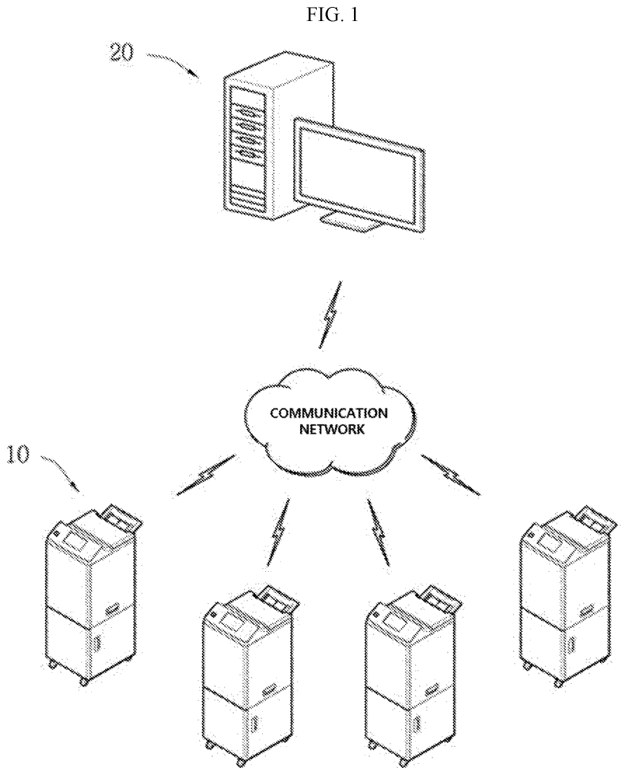

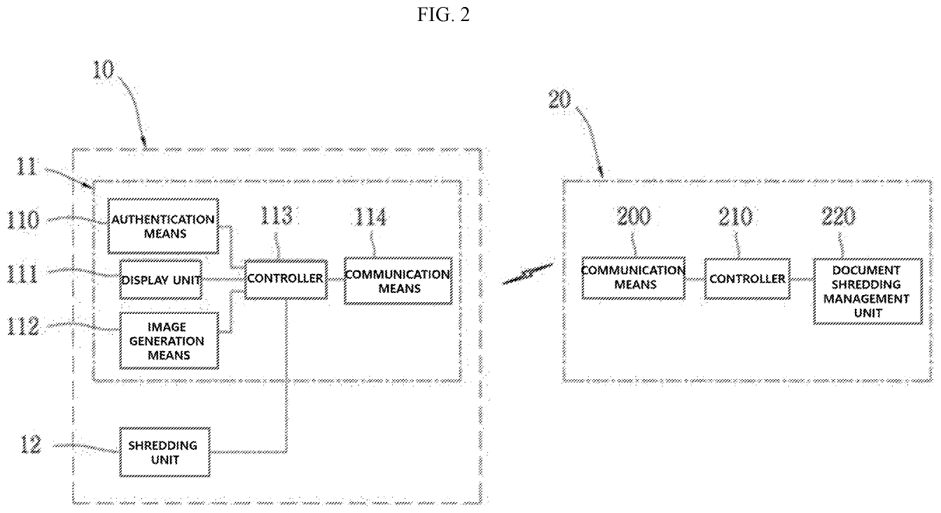

FIG. 1 is a system configuration view of a document shredding apparatus according to an embodiment of the present invention, and FIG. 2 is a system block diagram of the document shredding apparatus according to the embodiment of the present invention.

Referring to these figures, a document shredding apparatus having a document management apparatus according to an embodiment of the present invention includes at least one document shredder 10 and a server 20 connected to the document shredder 10 over a network for managing documents.

The document shredder 10 includes a control communication unit 11 and a shredding unit 12.

The control communication unit 11 includes an authentication means 110, a display unit 111, an image generation means 112, a controller 113, and a communication means 114.

The authentication means 110 allows authentication information of a person who requests that documents be shred to be input therethrough, and one of a fingerprint recognizer, an iris recognizer, an IC card reader, a magnetic card reader, and an RFID reader is adopted as the authentication means. In addition, the authentication means includes a touchpad that is capable of digitizing the signature of a user or a keypad that allows user information, such as employee number, to be input therethrough.

The authentication information of the person who requests that documents be shred, which is input through the authentication means 110, is transmitted to the server 20 through the controller 113 and the communication means 114 such that shredding request records are stored in the server.

The display unit 111 displays the authentication state of the authentication means 110, images of documents generated by the image generation means 112, and a process of guiding the input of document information about non-security documents or documents having no document identification means. Preferably, the display unit includes a touchscreen that allows information to be input therethrough.

The image generation means 112 includes a scanner or a digital camera. In the case in which user authentication is performed by the authentication means 110, the image generation means reads out document identification means of security documents, generates images of documents requested to be shred, and transmits information about the read-out document identification means of the security documents and the generated document images to the server 20 via the communication means 114.

The document identification means may be constituted by, for example, a quick response (QR) code or a barcode, and may include information about a document writer, document generation date, and document retention duration.

The controller 113 converts information about the person who requests that documents be shred, acquired from the authentication means 110, document information acquired from the image generation means 112, and document information input by the person who requests that documents be shred into a signal that is capable of being transmitted to the server such that the signal is transmitted to the server via the communication means 114.

In addition, the controller controls the operation of the shredding unit 12 according to a shredding command transmitted from the server 20.

The communication means 114 is constituted by an Ethernet communication module that is capable of performing short-range communication with the server 20, and is connected to a networking system, such as the Internet or an intranet, according to a protocol such that the server 20 is connected to the document shredder 10 over the network.

The communication means 114 transmits the authentication information of the person who requests that documents be shred, authenticated by the authentication means 110, security document information acquired from the image generation means 112, and general document images to the server 20 such that the server 20 constructs a shred document database and generates a control signal for shredding, and receives the control signal for document shredding from the server 20.

The server 20 is connected to the document shredder 10 over the network in order to manage documents.

The server 20 includes a communication means 200, a controller 210, and a document shredding management unit 220.

The communication means 200 is constituted by an Ethernet communication module that is capable of performing short-range communication with the server 20, and is connected to a networking system, such as the Internet or an intranet, according to a protocol such that the server 20 is connected to the document shredder 10 over the network.

The controller 210 compares the document information acquired from the image generation means 112 by the person who requests that documents be shred with document information stored in the document shredding management unit 220 in order to determine whether the acquired document information is identical to the stored document information.

Upon determining that the acquired document information is identical to the stored document information, the controller performs control such that a process of shredding the documents requested to be shred is displayed on the display unit 111 of the document shredder 10.

The document shredding management unit 220 includes a database, in which information about the security documents printed by a printing system, i.e. information about the document identification means, is stored. In addition, the employee information of the person who requests that documents be shred, input through the authentication means 110 of the document shredder 10, images of the documents requested to be shred, generated by and received from the image generation means 112 of the document shredder 10, and information related to the images are stored in the database.

In addition, the result of authentication, performed through the authentication means 110, and the result of shredding of the documents requested to be shred, performed by the document shredder 10, are stored in the database, whereby it is possible to perform document management, such as whether or not to discard documents to be discarded.

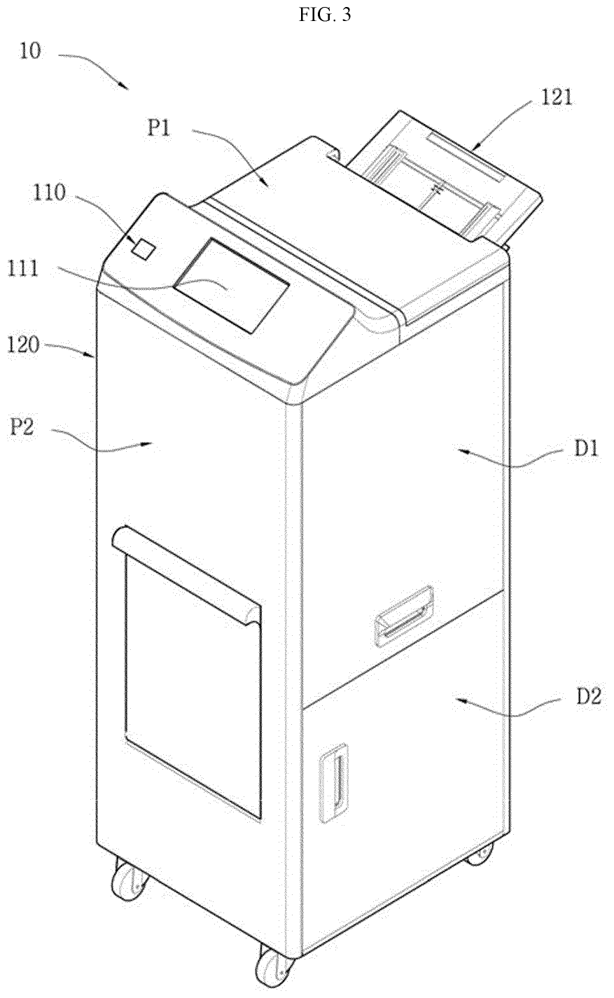

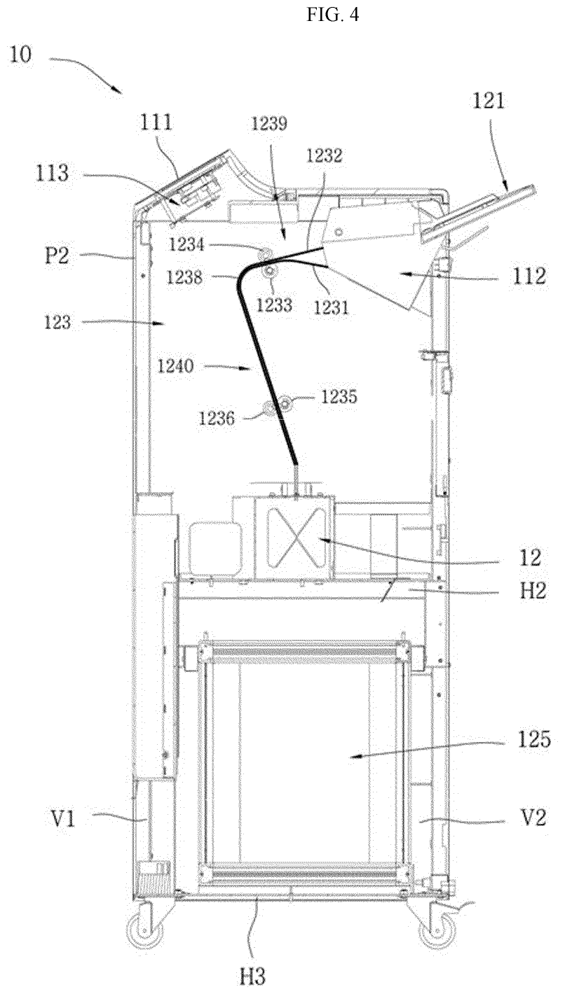

FIG. 3 is a perspective view showing the external appearance of the document shredder 10 according to the embodiment of the present invention, and FIG. 4 is a vertical sectional view showing the internal structure of the document shredder 10 according to the embodiment of the present invention.

Referring to these figures, the document shredder 10 includes a case 120, a document feeder 121, a guide means 123, a shredding unit 12, and a collection box 125.

The case 120 is formed based on a frame F.

The frame F includes vertical frames V1 and V2 disposed vertically at front and rear four sides and a first horizontal frame H1, a second horizontal frame H2, and a lower frame H3 fixed between the vertical frames V1 and V2 in the horizontal state.

The document feeder 121, the authentication means 110, the image generation means 112, and the controller 113 are formed at an upper panel P1 formed at the upper part of the case 120, and an upper door D1 and a lower door D2 are formed at the side surface of the case.

In the interior of the case that is opened by the upper door D1, the image generation means 112, the guide means 123, and the shredding unit 12 are formed on the first horizontal frame H1 and the second horizontal frame H2. In the interior of the case that is opened by the lower door D2, the collection box 124 is formed on the lower frame H3.

The document feeder 121 is installed at the rear of the case 120, and may include a well-known document feeding apparatus, for example, an apparatus mounted to the case 120 so as to be foldable and configured to feed a lowermost sheet from among a plurality of stacked documents. The document feeding apparatus is well known and may be easily embodied by a person having an ordinary skill in the art, and therefore a detailed description thereof will be omitted.

Both documents having a document identification means and documents having no document identification means may be used as documents that are placed on the document feeder 121 and shred.

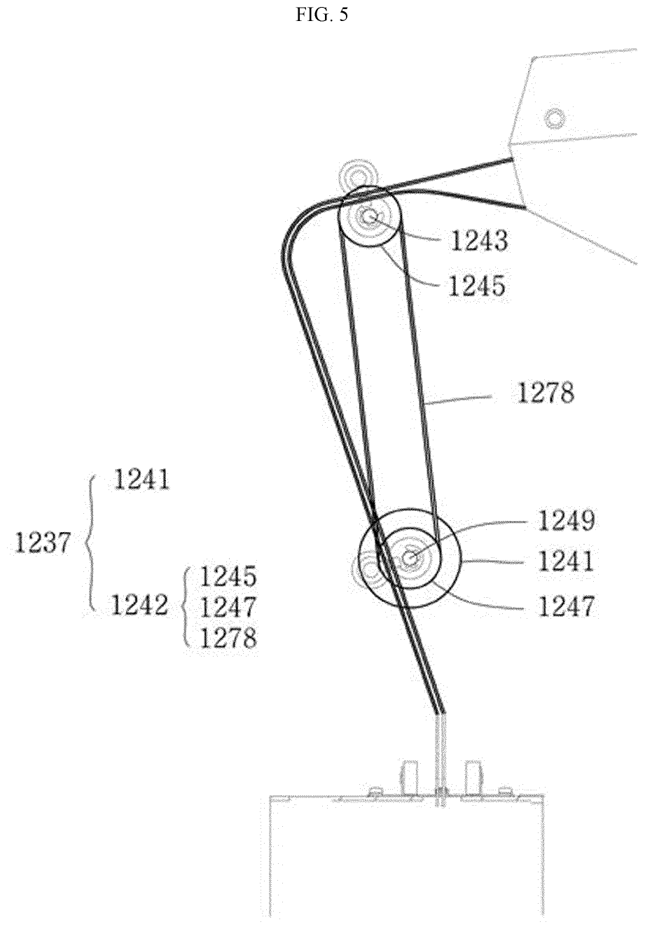

FIG. 5 is an enlarged view of the guide means of the present invention.

Referring to this figure, the guide means 123 includes a pair of guide chutes 1231 and 1232, a pair of upper feeding rollers 1233 and 1234, a pair of lower feeding rollers 1235 and 1236, and a driving device 1237.

The guide chutes 1231 and 1232 are disposed between the image generation means 112 and the shredding unit 12 so as to be spaced apart from each other by a gap through which approximately one sheet of a document can pass, and are installed so as to be spaced apart from each other by an appropriate distance in order to guide the documents requested to be shred, discharged from the image generation means 112.

In addition, an inlet side located at a discharge port of the image generation means 112 is inclined at an inclination angle of about 10 to 15 degrees in order to smoothly receive the documents discharged from the image generation means 112.

A curved portion 1238, at which the guide chutes 1231 and 1232 are bent so as to have circumferential surfaces having the same center, is formed at one side of a first inclined feeding unit 1239, and a second inclined feeding unit 1240 is formed so as to extend from the curved portion 1238 to an inlet side of the shredding unit 12.

The upper feeding rollers 1233 and 1234 are installed at the first inclined feeding unit 1239 of the guide chutes 1231 and 1232, and the lower feeding rollers 1235 and 1236 are installed at the second inclined feeding unit 1240.

The upper feeding rollers 1233 and 1234 and the lower feeding rollers 1235 and 1236 are installed so as to be spaced apart from the guide chutes 1231 and 1232 by an appropriate distance, are driven by power from the driving device 1237, and guide the documents requested to be shred, discharged from the image generation means 112 and guided by the guide chutes 1231 and 1232, to the shredding unit 12.

The driving device 1237 includes a motor 1241 and an electric-powered belt mechanism 1242.

The motor 1241 has a deceleration means, and power decelerated by the deceleration means simultaneously drives the upper feeding rollers 1233 and 1234 and the lower feeding rollers 1235 and 1236 via the electric-powered belt mechanism 1242.

The electric-powered belt mechanism 1242 includes an upper pulley 1245 fixed to a stationary shaft 1243 of the upper feeding roller 1233, a lower pulley 1247 fixed to a stationary shaft 1246 of the lower feeding roller 1235, and an electric-powered belt 1248 installed at the upper pulley 1245 and the lower pulley 1247.

A stationary shaft 1249 of the lower pulley 1247 serves as a driving shaft of the motor 1241.

Consequently, the lower pulley 1247 fixed to the stationary shaft 1249 and the upper pulley 1245, which is connected to the lower pulley via the electric-powered belt 1248, may be simultaneously driven by power from the motor 1241.

Any of various kinds of general document shredding structures is applied to the shredding unit 12. The document shredding structures may also be easily embodied by a person having an ordinary skill in the art, and therefore a detailed description thereof will be omitted.

The collection box 125 is installed under the shredding unit 12 in order to collect scraps of the documents shred by the shredding unit 12, and may be introduced into and removed from the case 120 by opening the lower door 107.

Hereinafter, the operation of the embodiment of the present invention will be described.

According to the present invention, when information about a person who requests that documents be shred, acquired from the authentication means 110 of the document shredder 10, which grasps the identity of the person who requests that documents be shred, is transmitted to the server 20 through the controller 113 and the communication means 114 and 200 and then the server 20 authenticates the identity of the person who requests that documents be shred, documents to be shred, placed on the document feeder 121, pass through the image generation means 112 and are then discharged to the shredding unit 12 while being guided by the guide means 123 according to a driving signal of the controller 113.

Document information is read out from the documents requested to be shred passing through the image generation means 112 by the document recognition means, scanned images of the documents are transmitted to the server 20 through the controller 113 and the communication means 114 and 200 and are stored in the document shredding management unit 220, and a shredding signal is transmitted to the document shredder 10 through the controller 210 such that the documents requested to be shred are shred.

At this time, in the case in which the documents to be shred are general documents, rather than security documents, an input window that allows document information, such as document writing date, document number, and relevant department, to be input therethrough is displayed on the display unit 111.

Consequently, the person who requests that documents be shred inputs information about the general documents using the touchpad of the display unit 111, the input information is stored in the server 20, and a shredding signal is transmitted to the document shredder 10 through the controller 210 such that the documents requested to be shred are shred.

The documents requested to be shred, discharged from the image generation means 112, are guided by the guide chutes 1231 and 1232, and are supplied to the shredding unit 12 by the driving device 1237.

The shredding signal from the server 20 drives the driving device 1237 and the shredding unit 12 through the controller 113 of the document shredder 10.

The documents to be shred, after reaching the shredding unit 12, are shred, and the shred documents are collected in the collection box 125.

Shredding information of the documents to be shred is transmitted to the server 20 via the communication means 114, and is stored in the document shredding management unit 220.

According to the above-described embodiment, information and images of documents that are shred and discarded by the document shredder are stored in the server, whereby it is possible to read the documents that are shred and discarded and to output the documents that are shred and discarded through the printing system. Consequently, it is possible to restore documents that have been normally discarded or documents that have been shred and discarded on purpose or due to carelessness.

The present invention has been described based on the preferred embodiment thereof.

The embodiment described in this specification and the construction shown in the drawings are related to the most preferred embodiment of the present invention, and does not cover all technical ideas of the present invention, and therefore it should be understood that there may be various equivalents and modifications capable of substituting for the same.

Consequently, the present invention is not limited to the suggested embodiment, and it is obvious that various modifications and alternations are possible by a person having an ordinary skill in the art to which the present invention pertains within the technical idea of the present invention and an equivalent range of the technical idea described in the appended claims.

1. A document shredding apparatus having a document management apparatus, the document shredding apparatus comprising:
a document shredder (10), the document shredder comprising:
a document feeder (121) formed at an upper part of a case (120);
a shredding unit (12) disposed in the case (120) so as to be located under the document feeder (121), the shredding unit being configured to shred documents introduced thereinto; and
a collection box (125) configured to collect scraps of the documents shred by the shredding unit (12),
at least one document shredder (10) being located at a terminal configured to manage documents; and
a server (20) connected to the document shredder (10) over a network, the server being configured to manage documents, wherein
the server (20) is configured to store document information and image information of documents requested to be shred from the document shredder (10).

2. The document shredding apparatus according to claim 1, wherein the document shredder (10) comprises:
an authentication means (110) configured to authenticate a person who requests that documents be shred;
a display unit (111) configured to display a shredding process of documents shred while passing through the shredding unit (12);
an image generation means (112) configured to generate images of the documents requested to be shred, which have been supplied from the document feeder (121) after authentication has been completed by the authentication means (110);
a communication means (114) configured to transmit authentication information of the person who requests that documents be shred, acquired from the authentication means (110), and the images of the documents requested to be shred, acquired from the image generation means (112), to the server (20); and
a guide means (123) configured to transfer documents from the image generation means (112) to the shredding unit (12).

3. The document shredding apparatus according to claim 1, wherein the server (20) comprises:
a communication means (200) connected to the document shredder (10) over a network; and
a document shredding management unit (220) configured to store information about a document identification means of security documents generated by the image generation means (112), employee information of the person who requests that documents be shred, input through the authentication means (110) of the document shredder (10), image and document information of the documents requested to be shred, generated by and received from the image generation means (112), and a result of shredding of the documents requested to be shred, performed by the document shredder (10).

4. The document shredding apparatus according to claim 1, wherein
the document shredder (10) further comprises a guide means (123),
the guide means (123) comprising:
a pair of guide chutes (1231, 1232) configured to guide the documents requested to be shred, discharged from the image generation means (112);
a pair of feeding rollers (1233, 1234) (1235, 1236) installed so as to be spaced apart from the guide chutes (1231, 1232) by an appropriate distance; and
a driving device (1237) configured to drive the pair of feeding rollers (1233, 1234), whereby the guide means guides the documents discharged from the image generation means (112) to the shredding unit (12).

5. The document shredding apparatus according to claim 4, wherein the guide chutes (1231, 1232) comprise:
a first inclined feeding unit (1239) having an inlet side located at a discharge port of the image generation means (112), the inlet side being formed so as to be inclined in order to smoothly receive the documents discharged from the image generation means (112);
a curved portion (1238) extending from the first inclined feeding unit (1239); and
a second inclined feeding unit (1240) extending from the curved portion (1238) so as to reach an inlet side of the shredding unit (12).

6. The document shredding apparatus according to claim 2, wherein the authentication means (110) is any one adopted from among a fingerprint recognizer, an iris recognizer, an IC card reader, a magnetic card reader, and an RFID reader.

7. The document shredding apparatus according to claim 3, wherein the document identification means is constituted by a quick response (QR) code or a barcode.

8. The document shredding apparatus according to claim 3, wherein the document shredding management unit (220) is related to the document identification means, and a document generation date, information about a document writer, authentication information of a user capable of using the document shredding apparatus, and security level information of documents are stored in a storage means.

9. The document shredding apparatus according to claim 3, wherein the display unit (111) of the document shredder (10) is configured to display a process of guiding input of document information about non-security documents or documents having no document identification means, generated by the image generation means (112), and comprises a touchscreen configured to allow the document information to be input therethrough.
